(19) United States
(12) Patent Application Publication
(10) Pub. No.: US 2009/0295830 A1
(43) Pub. Date: Dec. 3, 2009

(54) USER INTERFACE FOR INSPECTION OF PHOTOGRAPHS

(75) Inventors: Oleg MURAVEYNYK, Bracknell (GB); Jon EWINS, Ashford (GB); Peter Daniel COLLINS, Bracknell (GB); Nicholas J.N. MURPHY, Long Hill House (GB)

Correspondence Address: CREATIVE LABS, INC.;LEGAL DEPARTMENT, 1901 MCCARTHY BLVD, MILPITAS, CA, 95035, US

(73) Assignee: 3DLabs Inc., Ltd., Hamilton (BM)

(21) Appl. No.: 12/482,387

(22) Filed: Jun. 10, 2009

Related U.S. Application Data
(63) Continuation of application No. 11/567,689, filed on Dec. 6, 2006.
(60) Provisional application No. 60/744,593, filed on Apr. 10, 2006.
(60) Provisional application No. 60/597,534, filed on Dec. 7, 2005.

(51) Int. Cl. G09G 5/00; G06F 3/048

(52) U.S. Cl. 345/629; 715/781; 715/833

(57) ABSTRACT

A method of displaying images on the display screen of a portable electronic device includes presenting the overall image according to a first magnification level and a selected region in accordance with a second magnification level. The second region is superimposed over the overall image and is activated by a user input.

### RELATED APPLICATIONS

This application is a continuation-in-part of U.S. application Ser. No. 11/567,689 filed on Dec. 6, 2006 and entitled Methods for Manipulating Web Pages, which claims priority from and the benefit of U.S. Provisional Application No. 60/597,534, entitled Graphical User Interface for Portable Devices, filed on Dec. 7, 2005, and U.S. Provisional Application No. 60/744,593, entitled Methods for Manipulating Web Pages, filed on Apr. 10, 2006, the specifications of which are incorporated herein by reference in their entirety.

### BACKGROUND OF THE INVENTION

1. Field of the Invention

The present invention relates to user interfaces. More particularly, the present invention relates to methods for inspecting photographs and image content on user interface display screens.

2. Description of the Related Art

As portable electronic devices become increasingly sophisticated it is becoming more routine for such devices to include photographic functionality, or the ability to display photographic or other digital images via a display screen. Advances in display technology have made it increasingly possible to display graphic images on small and portable display screens that complement consumer devices such as cellular telephones, digital media players, or the like. Unfortunately, the portable nature of these devices requires that the display screen size remains small. This small screen size often causes manufacturers to seek to improve visibility by including a zoom facility that enables display of a portion of the photograph or image across the full screen. The user may then pan the zoomed image to locate a region of interest in the image by user input mechanisms such as buttons or in some cases by touching a touch sensitive screen in a predetermined manner.

This method often provides unsatisfactory results as once the image is zoomed in, the end user will often not be able to locate the region of interest in the photograph without first zooming out to ascertain the general area of the photograph corresponding to the region of interest. The alternative to zooming out to regain one's bearings is to move blindly across the image until the region of interest is visible, typically a slow and frustrating process for the user.

It is desirable to provide the end user with an efficient and improved method of inspecting a photograph or image on a display screen of a portable electronic device.

### SUMMARY OF THE INVENTION

The present invention provides a user interface for inspection of photographs and other digital images on a user's portable electronic device.

In accordance with one embodiment, a method of displaying an image at multiple magnification levels is provided. An image is provided at a first magnification level. A spot zoom region is selected comprising a first region of the image for display at a second magnification level, the second magnification level being at a higher magnification level than the first. The display of the first region at the second magnification level is activated in a superimposed manner over the display of the remainder of the image at the first magnification level.

In accordance with another embodiment, a method includes activating a display of a first region at a second magnification level and selection of the first region occurs in response to a user touching the screen and deactivating the second magnification level occurs in response to the user removing his finger from the screen.

In one embodiment, a user interface for a portable electronic device includes a display screen capable of displaying an image. A user input mechanism enables and disables a spot zoom function comprising a bounded graphical area smaller then the displayed area of the image, wherein the spot zoom area presents a magnified view of a first portion of the image while the rest of the image remains unchanged.

These and other features and advantages of the present invention are described below with reference to the drawings.

### BRIEF DESCRIPTION OF THE DRAWINGS

FIG. 1 illustrates an image without a zoom function enabled in accordance with a conventional display screen.

FIG. 2 displays a 2× magnification of the image displayed in FIG. 1, employing the conventional methodology of enlarging the image as a whole.

FIG. 3 is an image with 2× zoom using spot magnification in accordance with one embodiment of the present invention.

FIG. 4 is an image with 2× zoom using non-linear spot magnification in accordance with one embodiment of the present invention.

FIG. 5 is an image with zoom using non-linear spot magnification in accordance with one embodiment of the present invention.

### DETAILED DESCRIPTION OF PREFERRED EMBODIMENTS

Reference will now be made in detail to preferred embodiments of the invention. Examples of the preferred embodiments are illustrated in the accompanying drawings. While the invention will be described in conjunction with these preferred embodiments, it will be understood that it is not intended to limit the invention to such preferred embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known mechanisms have not been described in detail in order not to unnecessarily obscure the present invention.

It should be noted herein that throughout the various drawings like numerals refer to like parts. The various drawings illustrated and described herein are used to illustrate various features of the invention. To the extent that a particular feature is illustrated in one drawing and not another, except where otherwise indicated or where the structure inherently prohibits incorporation of the feature, it is to be understood that those features may be adapted to be included in the embodiments represented in the other figures, as if they were fully illustrated in those figures. Unless otherwise indicated, the drawings are not necessarily to scale. Any dimensions provided on the drawings are not intended to be limiting as to the scope of the invention but merely illustrative.

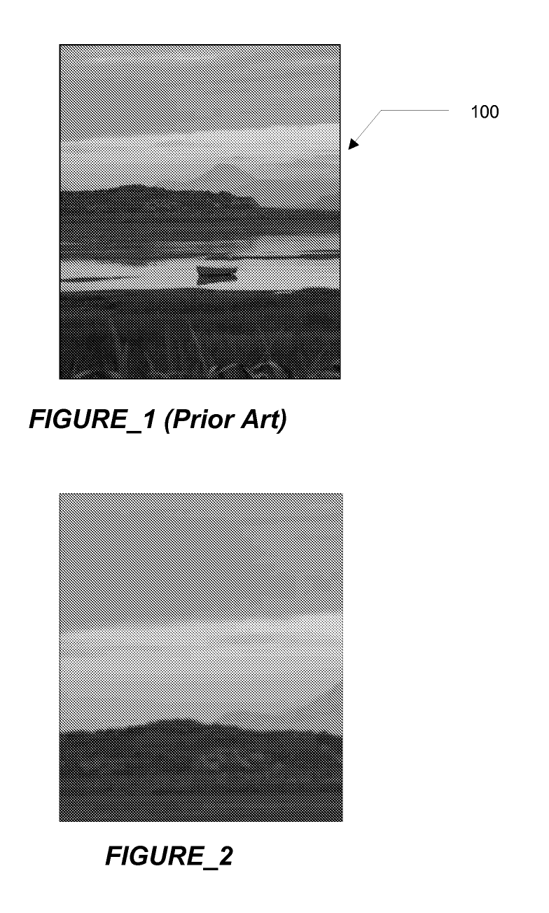

FIG. 1 illustrates an image 100 without a zoom function enabled in accordance with a conventional display screen. According to conventional techniques, a user desiring to inspect details as to the illustrated boat may zoom in by a factor of two. FIG. 2 displays a 2× magnification of the image displayed in FIG. 1, employing the conventional methodology of enlarging the image as a whole. Unfortunately, this activity can cause loss of the positioning of the boat, forcing the user to institute blind movements across the image until the boat is found.

Embodiments of the present invention provide methods of zooming or magnification of images displayed on portable electronic digital devices. In preferred embodiments, the display screen of the user interface presents zooming of selected regions of an image without losing one's position in the image currently displayed.

According to one embodiment, a method of displaying an image at multiple magnification levels includes providing a source image at a first magnification level. A first region of the image is selected for display at a second magnification level, the second magnification level being at a higher magnification level than the first, and enabling the display of the first region at the second magnification level in a superimposed manner over the display of the remainder of the image at the first magnification level.

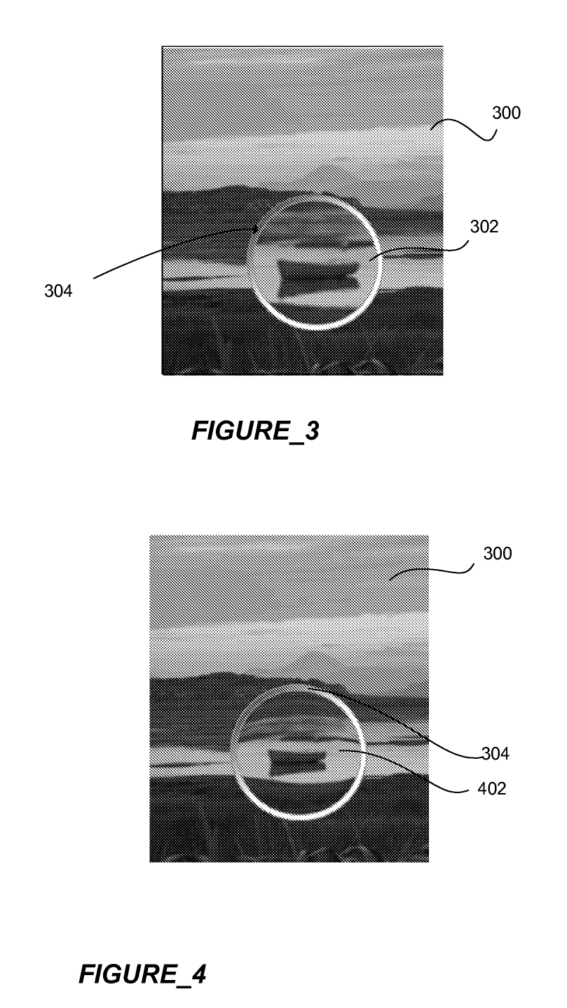

FIG. 3 is an image with 2× zoom using spot magnification in accordance with one embodiment of the present invention. In a preferred embodiment, the user touches the screen to enter an inspection mode, which activates the second magnification level, referred to hereinafter as spot zoom. When spot zoom is enabled a circular spot zoom region 302 (or other user selectable shape) of the displayed image will appear, with a frame 304 drawn around it to resemble a magnifying glass. According to this embodiment, the area bounded by the circular region (i.e., the first region of the original image) will be magnified, while the rest of the original image 300 will display in the unmagnified state, as depicted in FIGS. 3 and 4.

Preferably, the spot zoom region 302 will encompass a proportionate minority of the original image area, preferably between 5 and 50% of the original image area, more preferably between 10 and 25%, although these ranges are not intended to be limiting. As can be appreciated, a suitable size of the spot zoom area is a function of the display screen size and the level of detail in the original photograph, text, menu, or other image presented on the display screen. Hence, the scope of the invention includes spot zoom proportions of even lower than 5%, for example 1% or less, or more than 50%.

It should be appreciated further that other methods may be employed to activate the spot zoom function, including but not limited to user selectable activation buttons or other input mechanisms. With the touch sensitive screen, the spot zoom region can be positioned through selection of the region of the original image 300 where contact is made with the user's finger. Alternatively, scroll type buttons or other suitable input mechanisms known to those of skill in the relevant arts may be used by the user to position the activated spot zoom region.

In a preferred embodiment, the user moves the spot zoom magnifier around the displayed image to change the area inspected. As illustrated in FIG. 3, a preferred embodiment allows most of the image to remain visible, allowing the user to quickly position the spot zoom magnifier over the area to be inspected, and then move it to other areas as required, preferably by a swiping or sliding motion of the user's finger.

To further enhance flexibility, removal of the user's finger from the touch sensitive screen in the preferred embodiment causes the spot zoom magnification region to remain visible and in place. This allows the finger to be repositioned to avoid obscuring the area being inspected. In the preferred embodiment, it is not necessary for the finger to be in contact with the spot zoom to move it. That is, touching any part of the screen with a finger and moving it will suffice to cause movement of the spot zoom magnification region for inspection of other portions of the image.

In another embodiment, however, the spot zoom region is coupled to the finger contact, such that removal of the finger results in the removal of the spot zoom magnification region from the display screen and whereas movement of the finger on the screen results in corresponding movement of the spot zoom region.

In accordance with yet another embodiment, the spot zoom region shows inertial properties. That is, if the finger is still moving when it is taken off the screen the spot zoom continues to move, giving the appearance of a physical magnifying glass sliding across the surface of the image. When it reaches the edge of the screen it may alter its movement to give the appearance of bouncing off the side. In one embodiment, to accentuate that a border of the image has been reached, the shape of the spot zoom region may deform, as if the spot zoom region were elastic.

Preferably, the magnification of the spot zoom is user adjustable. In one embodiment, the magnification level is proportional to the pressure applied to the touch sensitive screen. The magnification may alternatively be set by using a slider positioned at the edge of the screen. The magnification is preferably modifiable while the spot zoom is in position. In an alternative embodiment, the user may set the magnification in a separate control prior to generating the spot zoom region on screen.

In a further alternative embodiment the amount of magnification given by the spot zoom may be configured to be 2×, 4×, 8×, or some other amount. Any data over which the magnifier may be moved is magnified. This data can include but is not limited to representations of photographic images, text, and menus.

Preferably the device is configured to automatically manage two or more sources corresponding to the image data. The magnified region should preferably be generated from data that is at a higher resolution than the unmagnified data. If higher resolution data is not available the data may be formed by scaling the same data displayed in unmagnified form with appropriate filtering. Suitable filtering methods are known to those of skill in the relevant arts and include but are not limited to interpolation and bicubic filtering.

Those skilled in the art will recognize that there are many alternatives to the preferred embodiments described herein that accomplish the same objective.

In an alternative embodiment the spot zoom may be square, rectangular, or some other shape not circular. Additionally, there may be a different border around the spot zoom, or no border at all.

In another embodiment the spot zoom may not continue to move after the user has removed their finger or other pointing device from the display. Additionally, the spot zoom may be controlled by buttons instead of direct interaction with the screen.

In a further alternative embodiment, the magnification of the image may not be constant across the area of the spot zoom. For example, the magnification may reduce at the edges of the spot zoom to the point where it is a reduction instead of a magnification, with the benefit that the entire image remains visible. FIG. 4 is an image with 2× zoom using non-linear spot magnification in accordance with one embodiment of the present invention. The spot zoom region 402 includes non-linear magnification. The outer portions of the spot zoom region 402 show a reduction from the original image magnification level (300) and transition to the 2× magnification level towards the center of the spot zoom region 402. While this diagram illustrates a gradual blending of magnification levels, in other embodiments the transition is more abrupt.

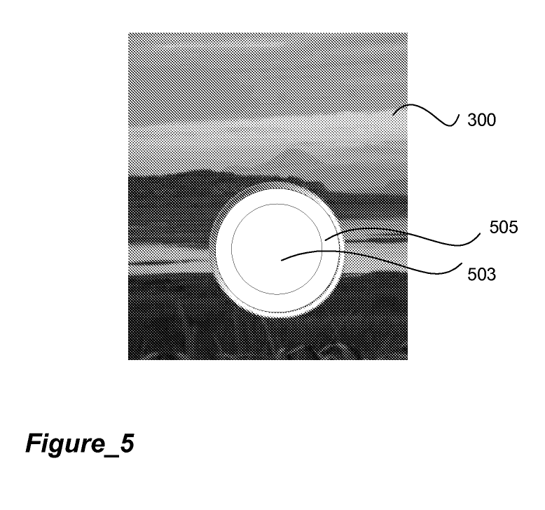

FIG. 5 is an image showing discrete magnification/reduction levels within the spot zoom region in accordance with one embodiment of the present invention. That is, region 503, the inner core of the spot zoom region can be magnifies with the user selectable magnification level, for a non-limiting example a 2× or 4× magnification. The transition region 505 in this embodiment represents a reduction from the original image 300. In this manner, the entirety of the content of the original image 300 (for example, the content illustrated in FIG. 1) can be presented.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of displaying an image at multiple magnification levels, the method comprising:
providing an image at a first magnification level;
selecting a spot zoom region comprising a first region of the image for display at a second magnification level, the second magnification level being at a higher magnification level than the first, and
activating the display of the first region at the second magnification level in a superimposed manner over the display of the remainder of the image at the first magnification level.

2. The method as recited in claim 1 wherein activating the display of the first region at the second magnification level and selection of the first region occurs in response to a user touching the screen and deactivating the second magnification level occurs in response to the user removing his finger from the screen.

3. The method as recited in claim 1 wherein activating the display of the first region at the second magnification level and selection of the first region occurs in response to a user touching the screen.

4. The method as recited in claim 3 wherein removal of the user's finger from the screen results in the first region at the second magnification level continuing to move across the image portion at the first magnification level.

5. The method as recited in claim 1 further comprising generating and displaying a transition area between the spot zoom area and the remainder of the image, the transition area containing a compressed display derived from the original image.

6. The method as recited in claim 5 wherein the transition area and the spot zoom area contains all of the content of the original image displaced by the combination of the spot zoom and the transition areas.

7. The method as recited in claim 1 wherein the content displayed in the spot zoom area is not constant across its area.

8. The method as recited in claim 1 wherein the magnification of the spot zoom region is dynamically changed by the user.

9. The method as recited in claim 8 wherein the change of magnification is proportional to pressure on the display screen.

10. The method as recited in claim 8 wherein the change of magnification is controlled by a slider menu present at an edge of the display screen.

11. The method as recited in claim 8 wherein data for the magnified portion of the image is generated from data of a higher resolution then the unmagnified data.

12. A user interface for a portable electronic device, said interface comprising;
a display screen capable of displaying an image;
a user input mechanism to enable and disable a spot zoom function comprising a bounded graphical area smaller then the displayed area of the image, wherein the spot zoom area presents a magnified view of a first portion of the image while the rest of the image remains unchanged.

13. The user interface of claim 12 wherein the user input mechanism for enabling or disabling the spot zoom functionality comprises one of pressure applied to a touch sensitive display screen, or pressure applied to an input key on said electronic device.

14. The user interface of claim 12 wherein the magnification of the spot zoom is user selectable and proportional to pressure on the display.

15. The user interface of claim 12 wherein the magnification of the spot zoom is user selectable and controlled by a slider menu present at an edge of the display screen.

16. The user interface of claim 12 wherein the degree of magnification of the spot zoom region is not constant across the spot zoom area.

17. The user interface of claim 12 wherein data for the spot zoom portion of the image is generated from data of a higher resolution then the unmagnified data.

18. The user interface of claim 12 wherein the spot zoom region is movable with respect to the background image on the display screen in response to user input.

19. The user interface of claim 18 wherein the spot zoom region moves in response to a user initiated sliding movement across the screen and continues to move after the sliding movement is removed from the screen.

20. A computer readable medium containing programming instructions for the operation of a user interface that presents a spot zoom function capable of magnifying a portion of an image while keeping another portion unchanged.
